(19) United States
(12) Patent Application Publication
(10) Pub. No.: US 2025/0194480 A1
(43) Pub. Date: Jun. 19, 2025

(54) AIR DISTRIBUTION SYSTEM AND BARRIER PREFERABLY FOR VERTICAL FARM INSTALLATIONS

(71) Applicant: FRM S.R.L., Rovereto (Trento) (IT)

(72) Inventor: Andrea Guglielmi, Este (Padova) (IT)

(73) Assignee: FRM S.R.L., Rovereto (Trento) (IT)

(21) Appl. No.: 18/852,216

(22) PCT Filed: Apr. 4, 2023
(86) PCT No.: PCT/IB2023/053388

§ 371 Date: Sep. 27, 2024

(30) Foreign Application Priority Data
Apr. 4, 2022 (IT) 102022000006614

(51) Int. Cl. A01G 31/02

(52) U.S. Cl. CPC A01G 31/025

(57) ABSTRACT

The present invention relates to a system for air circulation between a plurality of shelves of one or more vertically extending racks contained inside a closed environment. The system comprises: an air circulation unit configured to generate an air flow; a plurality of channels connected to said air circulation unit and configured to distribute air inside the closed environment by means of a direct air flow between the shelves of the racks; an internally hollow vertical wall comprising a first surface arranged in contact with a surface of a rack, said cavity of the wall being in fluid contact with at least one channel, said first surface comprising a plurality of holes configured to direct the air flow towards the outside of the shelves of the rack. The present invention also relates to a method for air circulation between a plurality of shelves of one or more vertically extending racks contained inside a closed environment.

### TECHNICAL FIELD

The present invention relates to a system and method for air circulation between a plurality of shelves of one or more vertically extending racks contained inside a closed environment.

In particular, the present invention can be applied in soilless farming techniques in “vertical farms”, containing agricultural products.

Air circulation means the distribution of an air flow, possibly conditioned. In particular, the air that is circulated and, according to requirements, is heated or cooled, made more or less humid and possibly mixed with gaseous mixtures containing more or less CO₂ or O₂ or O₃.

### PRIOR ART

In the state of the art, the farming of vegetable produce in closed environments is organised through a plurality of racks comprising a plurality of shelves on which individual growing trays are inserted and moved or they are organised on a wall.

The systems required for growing the vegetable produce are arranged on said racks. Such systems can comprise a lighting system, some systems for the monitoring and control of the environment and the produce, and an irrigation and fertilisation system.

As vertical farming is a type of farming in closed environments with a vertically extending configuration, a fundamental and underestimated aspect remains that of the climate control and ventilation of the environments. The reasons are also related to the physiological nature of the plant, as the correct temperature and humidity of the environment together with air circulation on the leaves improves the transpiration and thus the growth thereof.

In the state of the art, known solutions for circulating air inside a closed room envisage the installation of fans or “air vent” systems positioned directly on the shelf of the rack, in different positions, still with an “individual” management for each shelf.

Other solutions of the known type are based on the circulation of air in vertical movements, with air flows directed downwards, but which can only be applied in the case of “non-solid” shelves (i.e. perforated).

A drawback of known air circulation systems comes from the fact that by introducing an air flow along the vertical (with respect to the shelves and the floor of the closed environment on which the racks are positioned), thus moving the air with an intake at the top and a delivery at the bottom or vice versa, it is possible to obtain air circulation only in the case in which the shelves of the racks are perforated thus enabling the passage of the air flow.

A further drawback of known air circulation systems comes from the fact that with the fans installed at individual shelf level the distribution of the air takes place in a sector-based way, i.e. the air only moves perpendicularly to where the fan is active, creating “air channels”, thus some areas of the shelf do not receive equal quantities of air.

A further drawback of known air circulation systems comes from the fact that with fans installed at individual shelf level, each individual fan has a motor to make it turn and thus requires an electric power supply and a control system for switching it on and off, notably increasing the complexity of the installation.

Furthermore, each fan can break down, requiring maintenance, which certainly represents a single point of failure.

A further drawback of known air circulation systems comes from the fact that the distribution of air on the crops (in terms of quantity, temperature and humidity) is not uniform and not optimised for the uniform growth thereof.

The object of the present invention is to provide a system and a method for air circulation that enables uniform air circulation to be guaranteed between the shelves of the racks.

Another object of the present invention is to provide a system and a method for the circulation of an air flow with specific temperature and humidity conditions, enabling the management of temperature and humidity parameters.

Another object of the present invention is also that of controlling any additional gases, e.g. CO₂, O₂ or O₃.

A further object of the present invention is that of providing a system and a method for air circulation that enables a single air introduction point to be obtained and that can be controlled in a centralised way.

Another object of the present invention is having a centralised system that has the aim of controlling, through the air circulation system, all the climatic elements that can affect the growth of the plants, by way of example, more CO₂ in the day and O₂ at night, higher and lower temperatures. Known systems have separate elements for managing the temperature, humidity, air circulation and CO₂. The system according to the present invention does all these operations outside the climate chamber and then everything is introduced together through “vertical cushions” which are punctually brought towards the plants.

Another object of the present invention is that of providing a system and a method for air circulation which is simple to perform and reliable.

A further object of the present invention is represented by the reduction of “single points of failure” as there is a centralised air management system which can be redundant, thus increasing its reliability.

Another object of the present invention is that of providing a system and a method for air circulation which enables optimal growth of the vegetable produce, minimising differences in temperature, humidity and air flow on the growing surfaces.

### AIM OF THE INVENTION

The present invention describes a system of air circulation in closed environments, particularly for vertical farms, according to what is described in the appended claim 1.

Other advantageous aspects of the method for air circulation in closed environments are described in the dependent claims 2 to 9.

The present invention further describes a system of air circulation in closed environments, particularly for vertical farms, according to what is described in the appended claim 10.

The invention grants the main technical effect of providing a system and method for air circulation in closed environments able to reproduce the ideal climate for growing agricultural produce, storing cheeses, books, and any other perishable goods and/or whose storage is affected by climate conditions.

Other technical effects of the present invention are those of:
creating an air circulation and diffusion system which enables optimal growth of agricultural produce, minimising differences in temperature, humidity and air flow on the shelves of the racks;
creating a centralised system that has the aim of controlling, through the air circulation system, all the climatic elements that can affect the growth of the plants, by way of example, more CO₂ in the day and more O₂ at night, higher and lower temperatures.

Known systems have separate elements for managing temperature, humidity, air circulation and CO₂;
generating convective motion by means of vertical walls that introduce air horizontally together with the use of intake channels provided at the top, thus enabling continuous circulation of air ideal to guarantee the uniformity thereof. The air starts from the bottom and is recovered at the top.

### BRIEF DESCRIPTION OF THE DRAWINGS

The aforesaid technical effects/advantages and other technical effects/advantages of the invention will emerge in greater detail from the description, provided below, of an example embodiment, given by way of non-limiting illustration with reference to the appended drawings.

FIG. 1 shows a perspective section of a closed environment containing the air circulation system according to the present invention.

FIG. 2 shows a detail of FIG. 1.

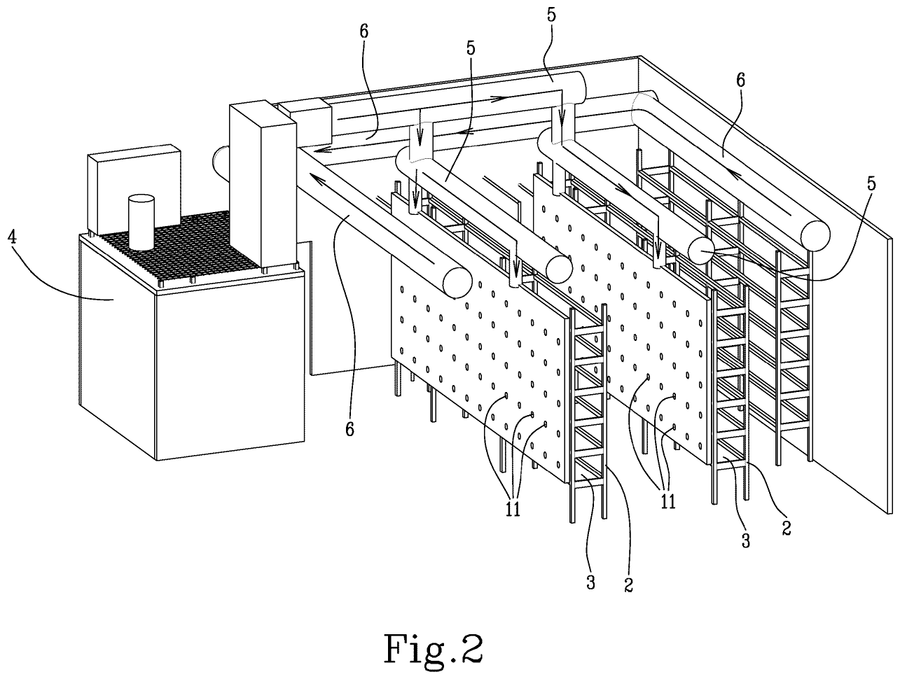

### DETAILED DESCRIPTION OF PREFERRED EMBODIMENTS OF THE INVENTION

In a first embodiment, the present invention describes an air circulation system in a closed environment, particularly for vertical farms, between the shelves of a plurality of racks extending substantially vertically.

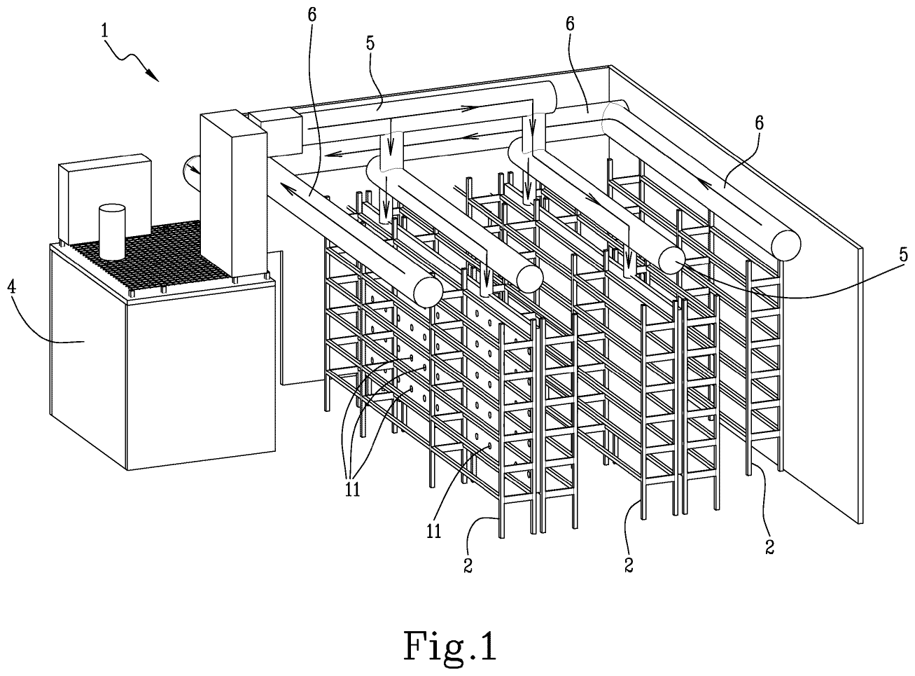

FIG. 1 shows a partial section of a closed environment, inside which there is one or more racks 2 extending substantially vertically wherein each rack 2 comprises one or more horizontal shelves 3, i.e. parallel with respect to the floor of the closed environment.

The system 1 for air circulation between the plurality of shelves 3 comprises a unit for air circulation 4 configured to generate an air flow, a plurality of channels 5, 6 connected to said air circulation unit 4 and configured to distribute air inside the closed environment by means of a direct air flow between the shelves 3 of the racks 2.

The air circulation unit 4 is arranged externally to the closed environment to be climate controlled.

The air circulation unit 4 is also able to treat or condition the air controlling, for example, the humidity (introduction of moist or de-humidified air), the temperature (hot or cold air) and the oxygen and/or CO₂ level.

The system 1 comprises one or more vertical walls 10, each of which is internally hollow.

Each vertical wall 10 is substantially parallelepiped shaped comprising a first surface arranged in contact with or near a surface of a rack 2, said cavity of the wall 10 is in fluid contact with at least one channel 5, 6 so as to be able to receive inside it an air flow, coming from the outside of the closed environment, introduced by the air circulation unit 4. The first surface of the vertical wall 10 comprises a plurality of holes 11 configured to direct and regulate the speed of the air flow received inside the cavity towards the outside of the shelves 3 of the rack 2.

Advantageously, each vertical wall 10 comprises a second surface, opposite said first surface, configured to be arranged in contact with a second rack 2 and also comprising a plurality of holes 11.

Preferably, the plurality of holes 11 is uniformly distributed on each of said first and second surface.

The air flow at the outlet from the plurality of holes 11 is substantially parallel to the shelves 3 of the racks 2 and thus parallel to the floor of the closed environment in which the racks are contained.

The air circulation unit 4 and the plurality of channels 5, 6 are configured to introduce and recover the air present inside the closed environment.

Each hole 11 of said plurality of holes has the same dimensions.

Alternatively each hole 11 of said plurality of holes 11 can have different dimensions or shapes.

The vertical wall 10 can be made of a rigid material, e.g. steel, plastic, marble.

The vertical wall 10 can be made of a soft material, preferably a plastic material.

Advantageously, the air circulation unit 4 is configured to treat the air at a controlled temperature and humidity level and CO₂ and O₂ .

The air circulation unit 4 can comprise a control unit configured to control the flow rate, temperature and humidity of the air flow introduced into said channels 5, 6.

There are also internal sensors to check the temperature, humidity, CO₂ level and oxygen level.

In a second embodiment, the present invention describes a method for air circulation between a plurality of shelves 3 of one or more vertically extending racks 2 contained inside a closed environment. The method comprises the steps of:
generating an air flow by means of an air circulation unit 4;
distributing the air inside the closed environment by means of a plurality of channels 5, 6 connected to said air circulation unit 4;
directing the air flow between the shelves 3 of the racks 2.

The invention has been described in the foregoing with reference to a preferential embodiment thereof.

However it is clear that the invention is susceptible to numerous variants which fall within the scope thereof, and which are technically equivalent.

1. A system for air circulation between a plurality of shelves of one or more vertically extending racks contained inside a closed environment, the system comprising:
an air circulation unit configured to generate an air flow;
a plurality of channels connected to said air circulation unit and configured to distribute air inside the closed environment by means of a direct air flow between the shelves of the racks; and
an internally hollow vertical wall comprising a first surface arranged in contact with a surface of a rack, said cavity of the wall being in fluid contact with at least one channel, said first surface comprising a plurality of holes configured to direct the air flow towards the outside of the shelves of the rack.

2. The system according to claim 1, wherein said wall comprises a second surface configured to be arranged in contact with a second rack and comprising a plurality of holes.

3. The system according to claim 1, wherein said air circulation unit and said plurality of channels are configured for the intake of the air present inside the closed environment.

4. The system according to claim 1, wherein each hole of said plurality of holes has equal dimensions.

5. The system according to claim 1, wherein each hole of said plurality of holes has different dimensions.

6. The system according to claim 1, wherein said wall is made of a rigid material.

7. The system according to claim 1, wherein said wall is made of a soft material, preferably plastic.

8. The system according to claim 1, wherein said air circulation unit is configured for treating air at controlled temperature and humidity.

9. The system according to claim 1, wherein said air circulation unit comprises a control unit configured to control the flow rate, temperature and humidity of the air flow introduced into said channels.

10. A method for air circulation between a plurality of shelves of one or more vertically extending racks contained inside a closed environment, comprising the steps of:
generating an air flow by means of an air circulation unit;
distributing the air inside the closed environment by means of a plurality of channels connected to said air circulation unit;
directing the air flow between the shelves of the racks.
